(19) United States
(12) Patent Application Publication
(10) Pub. No.: US 2009/0147078 A1
(43) Pub. Date: Jun. 11, 2009

(54) NOISE REDUCTION SYSTEM, ENDOSCOPE PROCESSOR, AND ENDOSCOPE SYSTEM

(75) Inventors: Nobuhiro TANI, Toyko (JP); Noriko IRIYAMA, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/327,895

(22) Filed: Dec. 4, 2008

(30) Foreign Application Priority Data
Dec. 5, 2007 (JP) 2007-315107

(51) Int. Cl. H04N 5/225

(52) U.S. Cl. 348/68; 348/E05.029

(57) ABSTRACT

A noise reduction system comprising a switch, a light-source controller, a memory and a noise reduction block, is provided. The switch switches an exposure method of a CMOS imaging device to global exposure. The CMOS imaging device generates an image signal on the basis of signal charges. The light-source controller orders illumination of the subject to be suspended during a receiving period in at least one field period after switching the exposure method to the global exposure. The signal charges are generated during the receiving period. The memory stores the image signal which is based on the signal charges generated during the suspension period as a black image signal. The noise reduction block removes fixed pattern noise from an optical image signal on the basis of the black image signal stored in the memory.

### BACKGROUND OF THE INVENTION

1. Field of the Invention

The present invention relates to a noise reduction system that reduces the effect of fixed pattern noise which appears in an image captured using global exposure in a CMOS imaging device mounted in an electronic endoscope.

2. Description of the Related Art

An electronic endoscope having an imaging device at a head end of an insertion tube is known. By transmitting illumination light emitted from the light source to the head end of an insertion tube through an optical fiber, a subject in a dark area, such as one inside the body, and internal mechanism, can be photographed and/or filmed.

An image with special visible effect can be displayed by using a special illumination method on a subject. For example, in a known technique, a subject is illuminated by pulsed light generated by pulse emission. By filming the vocal cords illuminated by pulsed light at a frequency adjusted to be nearly the same as the vibration of the vocal cords, an image of the quickly vibrating vocal cords, can be generated such that they appear to vibrate slowly.

If a user desires to observe a rapidly moving subject, then the user will usually select pulsed light. Accordingly, it is preferable for all the pixels to receive light simultaneously in order to capture an optical image of the subject using pulsed light illumination. On the other hand, if the user desires to observe a still or slowly moving subject, the user will select continuous light. Accordingly, when using continuous light illumination, it is preferable to generate an image signal in which noise in the captured image is reduced.

In order to film a subject with global exposure and also reduce noise, prior electronic endoscope has typically employed CCD imaging devices. The CCD imaging device, however, has some problems, e.g., high manufacturing cost of the CCD imaging device, high voltage requirement to drive the CCD imaging device, and requirement of many signal lines in a CCD imaging device.

To solve such problems, Japanese Unexamined Patent Publication No. 2002-58642 proposes that a CMOS imaging device with its lower power consumption and manufacturing cost than a CCD imaging device, be used for an electronic endoscope. However, noise is a significant problem in an image captured using global exposure in a CMOS imaging device.

### SUMMARY OF THE INVENTION

Therefore, an object of the present invention is to provide a noise reduction system that reduces noise generated in the capture of an image using global exposure in a CMOS imaging device.

According to the present invention, a noise reduction system comprising a switch, a light-source controller, a memory and a noise reduction block, is provided. The switch switches an exposure method of a CMOS imaging device to global exposure. The CMOS imaging device is mounted in an electronic endoscope. The CMOS imaging device generates an image signal on the basis of signal charges. The signal charges are generated by receiving an optical image of a subject. The light-source controller orders illumination of the subject with illumination light to be suspended during a receiving period in at least one field or one frame period after switching the exposure method to the global exposure. The signal charges are generated during the receiving period. The memory stores the image signal which is based on the signal charges generated during the suspension period, as a black image signal. Illumination of the subject with the illumination light is suspended during the suspension period. The noise reduction block removes fixed pattern noise from an optical image signal on the basis of the black image signal stored in the memory. The optical image signal contains the fixed pattern noise. The optical image signal is said image signal generated based on the signal charges generated while the subject is illuminated with the illumination light.

According to the present invention, a noise reduction system comprising a switch, an imaging device controller, a memory and a noise reduction block, is provided. The switch switches an exposure method of a CMOS imaging device to global exposure. The CMOS imaging device is mounted in an electronic endoscope. The CMOS imaging device generates an image signal on the basis of signal charges. The signal charges are generated by receiving an optical image of a subject. The imaging device controller orders the CMOS imaging device to generate the signal charges while illumination of the subject with illumination light is suspended in at least one field or one frame period after switching the exposure method to the global exposure. The memory stores the image signal which is based on the signal charges generated during the suspension period, as a black image signal. Illumination of the subject with the illumination light is suspended during the suspension period. The noise reduction block removes fixed pattern noise from an optical image signal on the basis of the black image signal stored in the memory. The optical image signal contains the fixed pattern noise. The optical image signal is said image signal generated based on the signal charges generated while the subject is illuminated with the illumination light.

### BRIEF DESCRIPTION OF THE DRAWINGS

The subjects and advantages of the present invention will be better understood from the following description, with reference to the accompanying drawings in which:

FIG. 1 is a block diagram showing the internal structure of an endoscope system having the noise reduction system of the first embodiment of the present invention;

FIG. 2 is a block diagram showing the internal structure of a light-source unit;

FIG. 3 is a block diagram showing the structure of an image-signal processing unit;

FIG. 4 is a flowchart illustrating the process of capturing and displaying in the first embodiment;

FIG. 5 is a flowchart illustrating the subroutine for generating a black image signal in the first embodiment;

FIG. 6 is a timing chart illustrating the timing to carry out some operations of the light-source unit and the imaging device in the first embodiment;

FIG. 7 is a first timing chart illustrating the timing to carry out some operations of the light-source unit and the imaging device in the second embodiment;

FIG. 8 is a flowchart illustrating the process of capturing and displaying in the second embodiment;

FIG. 9 is a flowchart illustrating the subroutine for generating a black image signal in the second embodiment; and

FIG. 10 is a second timing chart illustrating the timing to carry out some operations of the light-source unit and the imaging device in the second embodiment.

### DESCRIPTION OF THE PREFERRED EMBODIMENTS

The present invention is described below with reference to the embodiments shown in the drawings.

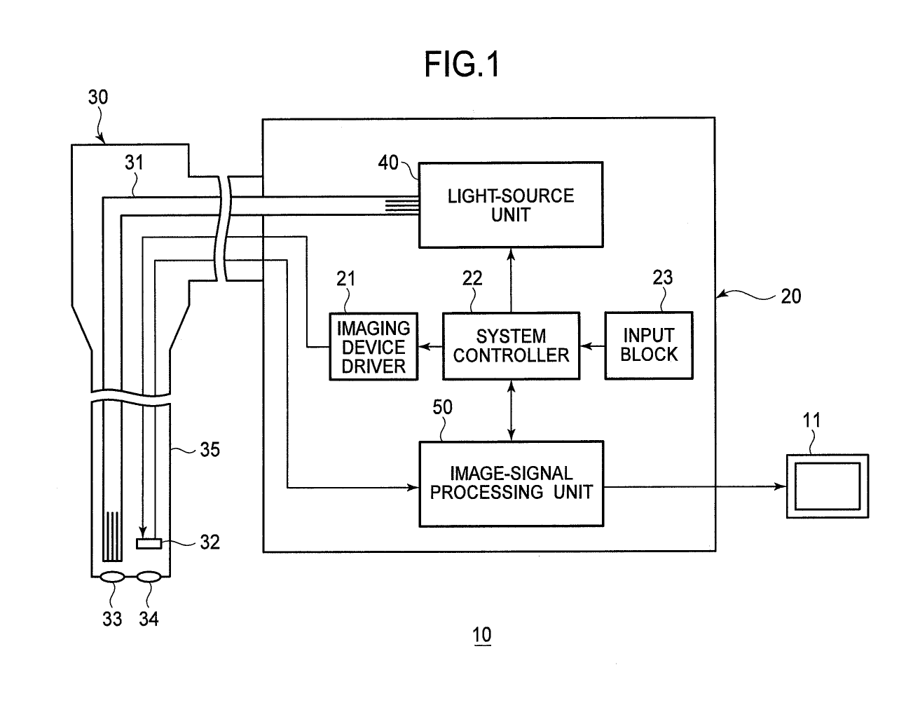

In FIG. 1, an endoscope system 10 comprises an endoscope processor 20, an electronic endoscope 30, and a monitor 11. The endoscope processor 20 is connected to the electronic endoscope 30 and the monitor 11.

The endoscope processor 20 emits illumination light to illuminate a required subject. The illuminated subject is photographed and/or filmed by the electronic endoscope 30, and then the electronic endoscope 30 generates an image signal. The image signal is sent to the endoscope processor 20.

The endoscope processor 20 carries out predetermined signal processing on the received image signal. The image signal, having undergone predetermined signal processing is sent to the monitor 11, where an image corresponding to the received image signal is displayed.

The endoscope processor 20 comprises a light-source unit 40, an image-signal processing unit 50, an imaging device driver 21 (switch, imaging device controller), a system controller 22 (first and second gain determination blocks, and status detector), an input block 23 (first input block, second input block), and other components.

As described below, the light-source unit 40 emits the illumination light for illuminating a desired subject toward the incident end of light guide 31. In addition, as described below, the image-signal processing unit 50 carries out predetermined signal processing on the image signal. In addition, an imaging device driver 21 drives an imaging device 32 to capture an optical image of a subject. In addition, the system controller 22 controls the operations of all components of the endoscope system 10. In addition, various kinds of functions of the endoscope system 10 are carried out by the user's input of operational commands to the input block 23.

By connecting the endoscope processor 20 to the electronic endoscope 30, the light-source unit 40 is optically connected to a light-guide 31 mounted in the electronic endoscope 30. In addition, by connecting the endoscope processor 20 to the electronic endoscope 30, electrical connections are made between the image-signal processing unit 50 and an imaging device 32 mounted in the electronic endoscope 30, and between the imaging device driver 21 and the imaging device 32.

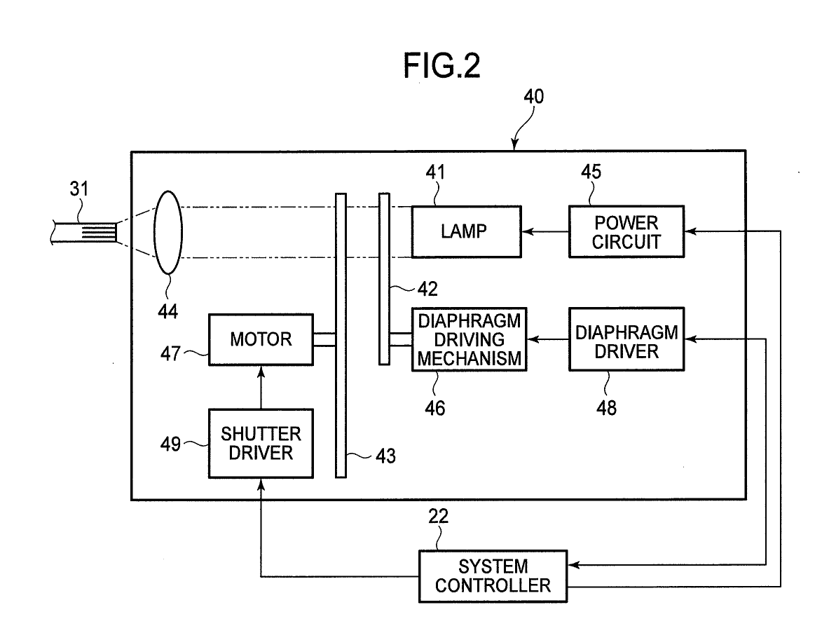

As shown in FIG. 2, the light-source unit 40 comprises a lamp 41, a diaphragm 42, a rotary shutter 43, a condenser lens 44, a power circuit 45, a diaphragm driving mechanism 46, a motor 47, a diaphragm driver 48, a shutter driver 49 (light-source controller), and other components.

The lamp 24 is, for example a xenon lamp or a halogen lamp, and emits white light. The diaphragm 42, the rotary shutter 43, and the condenser lens 44 are mounted on an optical path of white light from the lamp 41 to the incident end of the light guide 31.

The diaphragm 42 adjusts the amount of white light incident on the incident end of the light guide 31. The diaphragm driver 48 controls the diaphragm driving mechanism 46 so that the diaphragm driving mechanism 46 drives the diaphragm 42. The amount of light received by the imaging device 32 is communicated to the diaphragm driver 48 via the system controller 22. The diaphragm driver 48 orders the diaphragm 42 to adjust the aperture ratio of the diaphragm 42 on the basis of the amount of light. In addition, the adjusted aperture ratio is communicated to the system controller 22.

The rotary shutter 43 has a circular plate shape and has an aperture area and a blocking area. When white light should be emitted from the light-source unit 40, the aperture area is inserted into the optical path of white light. On the other hand, when the emission of white light should be suspended, the blocking area is inserted into the optical path of white light, blocking white light.

The motor 47 makes the rotary shutter 43 rotate. By controlling the rotation of the rotary shutter 43, the light-source unit 40 is successively and alternately switched between the emission of and the suspension of the emission of white light, then the light-source unit 40 emits a pulse of white light. In addition, by suspending the circulation of motor 47 with the aperture area inserted into the optical path, the light-source unit 21 continuously emits white light. On the other hand, by suspending the circulation of motor 47 with the blocking area inserted into the optical path, the light-source unit 40 suspends the emission of white light.

The motor 47 is driven by the shutter driver 49. The shutter driver 49 is controlled by the system controller 22.

White light emitted from the light-source unit 40 is condensed by the condenser lens 31, and is directed to the incident end of the light guide 31.

The power circuit 45 supplies the lamp 41 with power. The system controller 22 switches power supply to the lamp 41 from the power circuit 45 to power the lamp 41 on and off.

Next, the structure of the electronic endoscope 30 is explained in detail. As shown in FIG. 1, the electronic endoscope 30 comprises the light guide 31, the imaging device 32, a diffuser lens 33, an object lens 34, and other components.

The incident end of the light guide 31 is mounted in a connector (not depicted) which connects the electronic endoscope 30 to the endoscope processor 20. And the other end, hereinafter referred to as the exit end, is mounted at the head end of an insertion tube 34 of the electronic endoscope 30.

As described above, white light emitted from the light-source unit 40 arrives at the incident end of the light guide 31. The light is then transmitted to the exit end. The light transmitted to the exit end illuminates a peripheral area near the head end of an insertion tube 35 through a diffuser lens 33.

An optical image of reflection light of the subject illuminated by white light reaches a light-receiving surface of the imaging device 32 through the object lens 34. The imaging device receives an imaging device driving signal from the imaging device driver 21. The imaging device 32 captures an optical image and generates an image signal on the basis of the imaging device driving signal. Incidentally, the imaging device driver 21 is controlled by the system controller 22.

The imaging device 32 is a CMOS imaging device. Pixels (not depicted) are arranged in a grid on the light-receiving surface of the imaging device 32. Each pixel has a photodiode which generates a signal charge according to the amount of light received by the pixel. The generated signal charge is output as a pixel signal. The image signal consists of a plurality of pixel signals output form a plurality of pixels on the entire light-receiving surface. Accordingly, signal charges are finally converted into an image signal.

The imaging device driver 21 can order the imaging device to perform global exposure or line exposure to capture an optical image. With global exposure, the imaging device 32 captures an optical image by ordering all the pixels to simultaneously generate signal charges and to output each of the signal charges as a pixel signal in order. On the other hand, in line exposure, the imaging device 32 captures an optical image by ordering the pixels arranged in a given row to generate signal charges by row, and output each of the signal charges as a pixel signal in order. The imaging device driver 21 drives the imaging device 32 on the basis of the control of the system controller 22.

An image signal which is generated when an optical image of a subject arrives at the light-receiving surface is defined as an optical image signal, and corresponds to the captured optical image. In addition, an image signal which is generated without making any light incident on the light-receiving surface is defined as a black image signal, and is used for removing fixed pattern noise from the optical image signal. When an optical image signal is generated with global exposure, the imaging device 32 is ordered to generate the black image signal before generating the optical image signal. On the other hand, when an optical image signal is generated with line exposure, the imaging device 32 is ordered to generate only an optical image signal.

Incidentally, the black image signal is generated not only before generating an optical image signal with global exposure, but also when initializing the electronic endoscope 30. When an operational command for initializing the electronic endoscope 30 is input to the input block 23, the imaging device driver 21 orders the imaging device 32 to generate a black image signal.

For generating a black image signal, the system controller 22 controls the shutter driver 49 so that the emission of white light is suspended from the light-source unit 40 during one field or one frame period. Then, the system controller 22 regards an image signal generated by the imaging device 32 as a black image signal, and distinguishes the black image signal from optical image signals in signal processing.

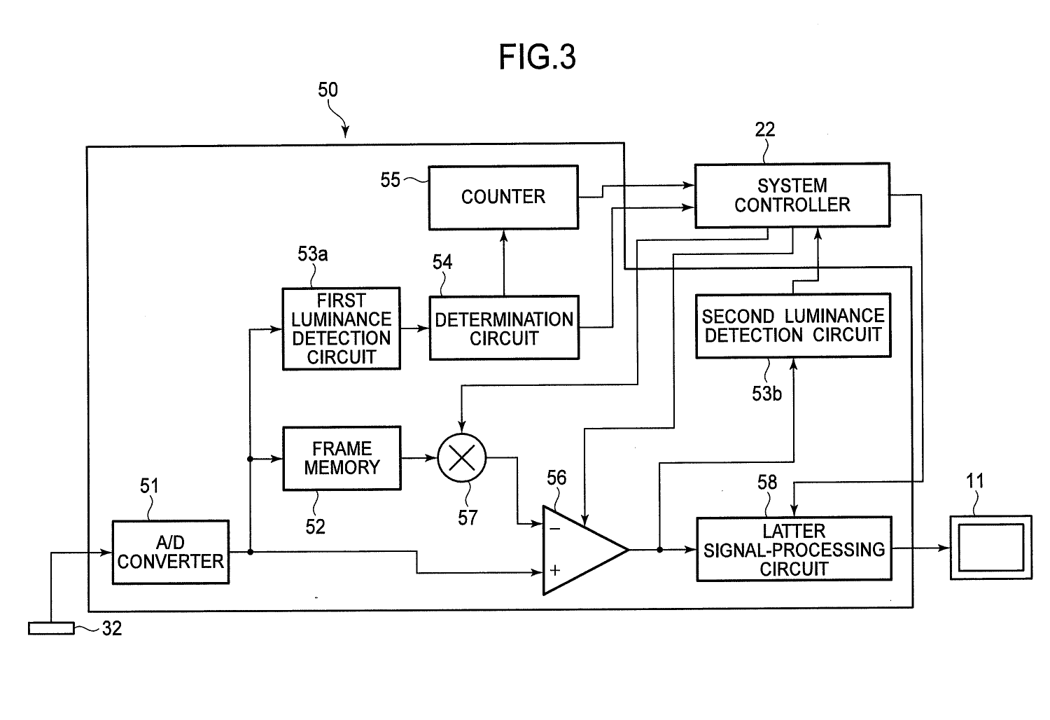

A black image signal and an optical image signal are sent to the image-signal processing unit 50. As shown in FIG. 3, the image-signal processing unit 50 comprises an A/D converter 51, a frame memory 52, first and second luminance detection circuits 53a and 53b (luminance calculation block), a determination circuit 54, a counter 55, an arithmetic circuit 56 (noise reduction block), a multiplier 57 (adjustment block), and a latter signal-processing circuit 58 (first warning block, second warning block).

The black image signal and the optical image signal input to the image-signal processing unit 50 are digitized by the A/D converter 51.

The digitized black image signal is sent to the frame memory 52 and stored thereby. The frame memory 52 is connected to the arithmetic circuit 56 via the multiplier 57. The black image signal stored by the frame memory 52 is amplified by the multiplier on the basis of the gain determined by the system controller 22.

The system controller 22 determines the gain in inverse proportion to the aperture ratio of the diaphragm 42. In addition, noise is removed in proportion to the determined gain, as described below. However, when the gain is determined to be too large, the accuracy of noise reduction diminishes. Finally, the amplified black image signal is sent to the arithmetic circuit 56.

On the other hand, the digitized optical image signal is sent to the arithmetic circuit 56. The arithmetic circuit 56 removes fixed pattern noise included in the optical image signal by subtracting the amplified black image signal from the received optical image signal.

The digitized black image signal is sent not only to the frame memory 52 but also to the first luminance detection circuit 53a. The first luminance detection circuit 53a detects the average luminance of an entire image corresponding to the received black image signal. The detected average luminance is communicated to the determination circuit 54.

The determination circuit 54 determines whether or not the average luminance exceeds a luminance threshold. The black image signal is equivalent to fixed pattern noise mixed in with an image signal on generation of the image signal, and the average luminance based on the black image signal is nearly zero. A value exceeding the luminance value which is usually estimated as fixed pattern noise is predetermined as the luminance threshold. Accordingly, when the average luminance exceeds the luminance threshold, it can be supposed that light is incident on the imaging device 32. The determination of the determination circuit 54 is communicated to the system controller 22.

When the average luminance is determined to be less than the luminance threshold, the system controller 22 controls the shutter driver 49 and the imaging device driver 21 so that an optical image device is generated. In addition, the system controller 22 controls the arithmetic circuit 56 to subtract the amplified black image signal from the generated optical image signal.

On the other hand, when the average luminance exceeds the luminance threshold, the system controller 22 controls the shutter driver 49 and the imaging device driver 21 so that a black image signal is generated. For generating a black image signal, the system controller 22 prevents the light-source unit 40 from emitting white light during one field or frame period, again. During the same period, the image signal is generated as a black image signal. The system controller 22 compares the average luminance based on the black image signal generated again, and the luminance threshold.

The determination circuit 54 is connected to the counter 55. The determination of the determination circuit 54 is also communicated to the counter 55. The counter 55 counts the repeating-number by adding one to the previously counted repeating-number when the average luminance is determined to exceed the luminance threshold. On the other hand, the counter 55 resets the repeating-number to zero when the average luminance is determined to be less than the luminance threshold. Accordingly, the repeating-number is the number of times when the average luminance exceeds the luminance threshold successively. The counted repeating-number is communicated to the system controller 22.

The system controller 22 orders a black image signal to be generated until the average luminance is less than the luminance threshold or until the repeating-number exceeds a number-threshold.

When the repeating-number exceeds the number-threshold, the system controller 22 controls the shutter driver 49 and the imaging device driver 21 so that an optical image signal is generated. In this case, the arithmetic circuit 56 outputs the generated optical image signal without subtracting the amplified black image signal from the optical image signal.

The arithmetic circuit 56 is connected to the latter signal-processing circuit 58 and the second luminance detection circuit 53b. An optical image signal output from the arithmetic circuit 56 is sent to the latter signal-processing circuit 58 and the second luminance detection circuit 53b.

The latter signal-processing circuit 58 carries out predetermined signal processing, such as gain control processing, white balance processing, and color interpolation processing, on the received optical image signal. In addition, if black image signals are repeatedly generated and the repeating-number is less than the number-threshold, the latter signal-processing circuit 58 carries out superimposition signal processing on the optical image signal so that a warning to instruct the user to block the end of the insertion tube is superimposed on an image corresponding to the optical image signal. If the repeating-number exceeds the number-threshold, the latter signal-processing circuit 58 carries out superimposition signal processing on the optical image signal so that a warning to inform that noise cannot be removed is superimposed on an image corresponding to the optical image signal.

An optical image signal, having undergone predetermined signal processing, is sent from the latter signal-processing circuit 58 to the monitor 11, where an image corresponding to the received optical image signal is displayed.

The second luminance detection circuit 53b detects average luminance of an entire image corresponding to the received optical image signal. The average luminance detected by the second luminance detection circuit 53b is communicated to the diaphragm driver 48 via the system controller 22 as the amount of light received by the imaging device 32, as described above.

The endoscope system 10 has a normal image mode and a vocal cord observation mode. A user can switch between the normal image mode and the vocal cord observation mode by inputting an operational command for switching to the input block 23. If a user selects the normal image mode, the light-source unit 40 is ordered to continuously emit white light and the imaging device 32 is ordered to perform line exposure to capture an optical image. On the other hand, if a user selects the vocal cord observation mode, the light-source unit 40 is ordered to emit pulse of white light and the imaging device is ordered to perform global exposure to capture an optical image.

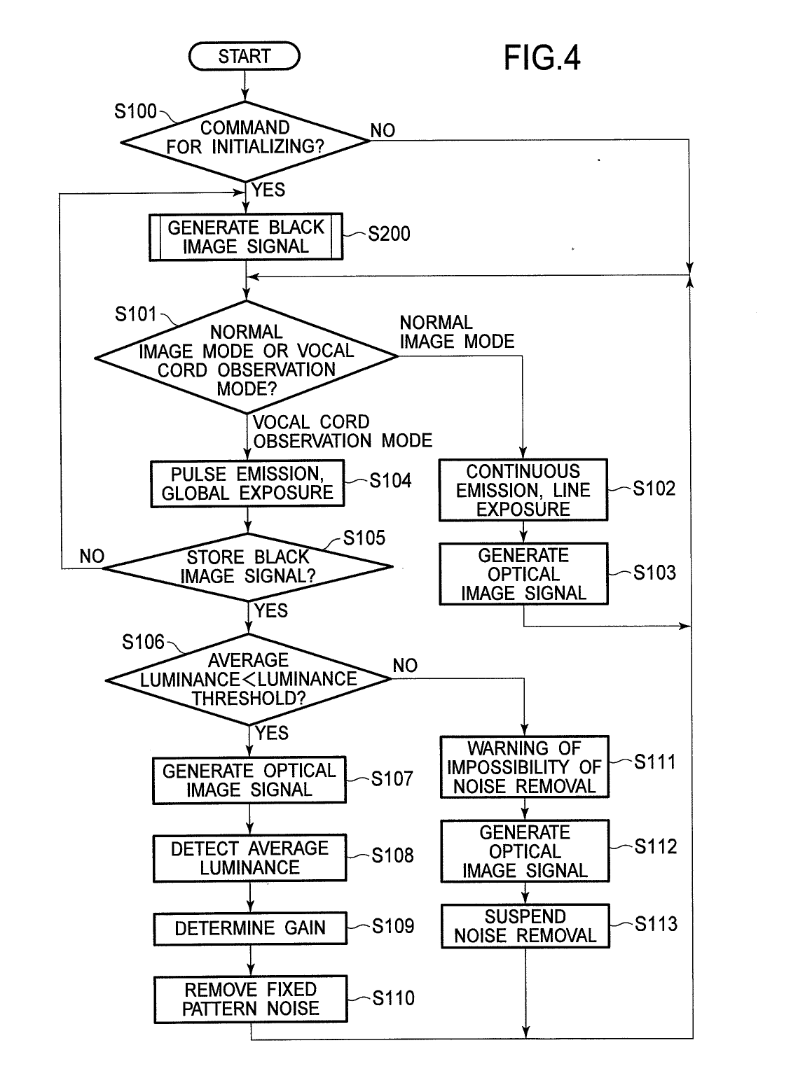

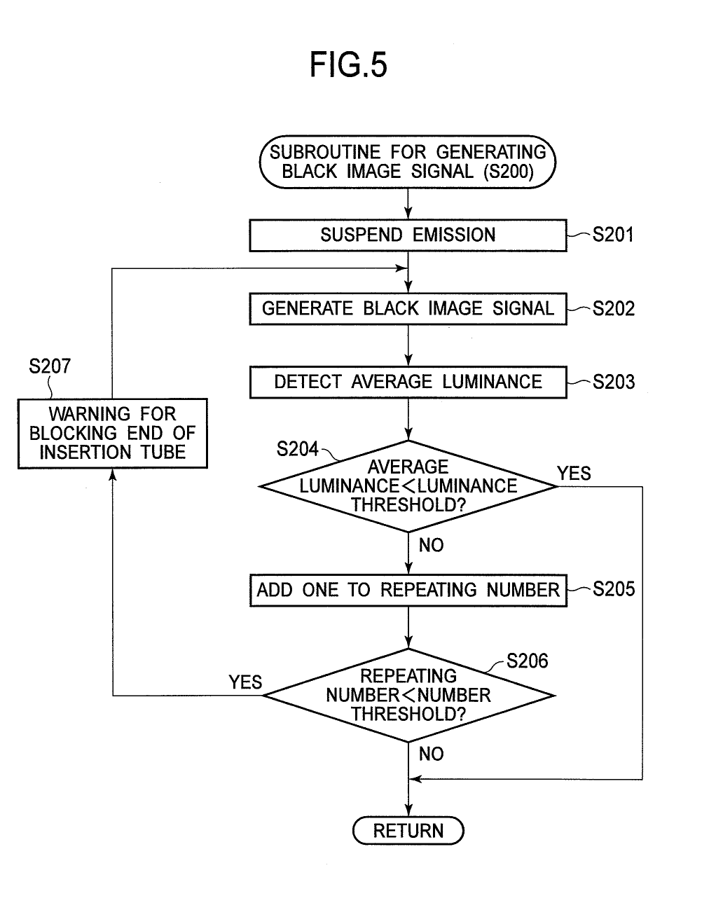

Next, the process used to capture an optical image of a subject and to display the image on a monitor 11 after commencing the endoscope system 20 in the first embodiment is explained using the flowcharts of FIGS. 4 and 5. The process of capturing and displaying terminates when the endoscope processor 20 is switched off.

At step S100, the system controller 22 determines whether or not the input block 23 detects an input of an operational command for initializing. When the input of the operational command is detected, the process proceeds to a subroutine for generating a black image signal (S200). On the other hand, when the input of the operational command is not detected, the process skips the subroutine and proceeds to step S101.

In the subroutine for generating a black image signal (S200), the shutter driver 49 and the imaging device driver 21 orders the rotary shutter 43 and the imaging device 32 so that a black image signal is generated, and the system controller 22 orders the frame memory 52 to store the generated black image signal, as described in detail below.

At step S101, the system controller 22 determines either the normal image mode or the vocal cord observation mode is selected.

If the normal image mode is selected, the process proceeds to step S102. At step S102, the system controller 22 orders the light-source unit 40 to continuously emit white light. In addition, the system controller 22 orders the imaging device driver 21 to drive the imaging device with line exposure.

At step S103 following step S102, the imaging device driver 21 orders the imaging device 32 to generate an optical image signal. In addition, the image-signal processing unit 50 carries out predetermined signal processing on the generated optical image signal with line exposure. The optical image signal, having undergone predetermined signal processing is sent to the monitor 11. After sending the optical image signal, the process returns to step S101.

If the vocal cord observation mode is selected at step S101, the process proceeds to step S104. At step S104, the system controller 22 orders the light-source unit 40 to emit pulsed white light. In addition, the system controller 22 orders the imaging device driver 21 to drive the imaging device 32 with global exposure.

At step S105 after ordering the imaging device driver 21, the system controller 22 determines whether the frame memory 52 stores a black image signal. When a black image signal is not stored, the process returns to a subroutine for generating a black image signal (S200). If a black image signal is stored, the process proceeds to step S106.

At step S106, the determination circuit 54 determines whether or not average luminance of an entire image corresponding to the black image signal generated at the subroutine S200 is less than the luminance threshold. When the average luminance is less than the luminance threshold, the process proceeds to step S107. On the other hand, when the average luminance exceeds the luminance threshold, the process proceeds to step S111.

At step S107, the imaging device driver 21 orders the imaging device 32 to generate an optical image signal, and then the process proceeds to step S108. At step S108, the second luminance detection circuit 53b detects average luminance of an image corresponding to the optical image signal generated at step S107. After detecting average luminance, the process proceeds to step S109. At step S109, the diaphragm driver 48 decides an aperture ratio of the diaphragm 42 based on the average luminance detected at step S107, and the system controller 22 decides a gain to multiply a black image signal by based on the decided aperture ratio.

At step S110 following step S109, the multiplier 57 multiplies the black image signal stored in the frame memory 52 by the gain decided at step S109. In addition, the arithmetic circuit 56 removes fixed pattern noise by subtracting the black image signal multiplied by the gain from the optical image signal generated at step S107. In addition, the latter signal-processing circuit 58 carries out predetermined signal processing on the optical image signal whose fixed pattern noise has been removed, and then the optical image signal is sent to the monitor 11. After sending the optical image signal, the process returns to step S101.

As described above, when the average luminance of an entire image corresponding to the black image signal exceeds the luminance threshold at step S106, the process proceeds to step S111. At step S111, the latter signal-processing circuit 58 superimposes a warning that noise cannot be removed, such as “image signal for noise removal is unavailable” on an image corresponding to the optical image signal.

At step S112 following step S111, the imaging device driver 21 orders the imaging device 32 to generate an optical image signal, and then the process proceeds to step S113. At step S113, the system controller 22 orders the arithmetic circuit 56 to suspend the removal of noise from the optical image signal. In addition, the latter signal-processing circuit 58 carries out predetermined signal processing on the optical image signal without removing noise, and then the optical image signal is sent to the monitor 11. After sending the optical image signal, the process returns to step S101.

Next, the subroutine for generating a black image signal (S200) in the first embodiment is explained below.

At step S201, the system controller 22 orders the light-source unit 40 to suspend the emission of white light while signal charge is accumulated in the entire frame period or the entire field period. After suspending the emission of white light, the process proceeds to step S202.

At step S202, the imaging device driver 21 orders the imaging device 32 to generate an image signal based on the signal charges which are generated during the suspension of the emission of white light. In addition, the system controller regards the generated image signal as a black image signal, and stores the black image signal in the frame memory 52. After the black image signal is stored by the frame memory, the process proceeds to step S203. At step S203, the first luminance detection circuit 53a detects the average luminance of an image corresponding to the stored black image signal.

At step S204, following the detection of the average luminance, the determination circuit 54 determines whether or not the average luminance detected at step S203 is less than the luminance threshold. When the average luminance is less than the luminance threshold, the process skips steps S205 and S206, and the subroutine for generating a black image signal (S200) ends. On the other hand, when the average luminance exceeds the luminance threshold, the process proceeds to step S205.

At step S205, the counter 55 adds one to the previous repeating-number, and then the process proceeds to step S206. At step S206, the system controller 22 determines whether the present repeating-number is less than the number-threshold.

When the present repeating-number is less than the number-threshold, the process then proceeds to step S207. At step S207, the latter signal-processing circuit 58 superimposes a warning to instruct the user to block an end of the insertion tube, such as “shield the head end of the scope from light” on an image corresponding to the optical image signal. After the warning is superimposed, the process returns to step S202. On the other hand, when the present repeating-number exceeds the number-threshold, the subroutine for generating a black image signal (S200) ends.

In the above first embodiment, even if the CMOS imaging device is ordered to perform global exposure for generating an optical image signal, fixed pattern noise can be sufficiently removed from the optical image signal. A larger amount of fixed pattern noise is generally mixed in with the optical image signal using global exposure in a CMOS imaging device than using line exposure. However, when an optical image signal is generated using global exposure, the effect of fixed pattern noise on an image corresponding to the optical image signal is reduced by generating a black image signal and subtracting the black image signal from the optical image signal generated using global exposure in the first embodiment above.

In addition, in the above first embodiment, a black image signal is generated when the electronic endoscope 30 is initialized. Without generating a black image signal before an observation, an image of a subject cannot be displayed at least for one field period because the black image signal must be generated before an optical image signal is taken. However, as in the first embodiment, by generating a black image signal when initializing the electronic endoscope 30, the image of a subject can be displayed soon, after switching to perform global exposure.

Next, a noise reduction system of the second embodiment is explained. The primary difference between the second embodiment and the first embodiment is the method of generating a black image signal. In the first embodiment, a black image signal is generated by ordering the generation of an image signal while ordering the suspension of the emission of white light during one field or frame period. On the other hand, in the second embodiment, a black image signal is generating by ordering the generation of an image signal while white light is not emitted from the light-source unit 40. The second embodiment is explained mainly with reference to the structures that differ from those of the first embodiment. Here, the same index numbers are used for the structures that correspond to those of the first embodiment.

The structure and the function of the light-source unit 40 are the same as those in the first embodiment. Accordingly, the light-source unit 40 is switched between pulse emission, continuous emission, and the suspension of emission of white light, based on the control of the system controller 22.

The structure and the function of the electronic endoscope are the same as those in the first embodiment. Accordingly, the imaging device driver 21 orders the imaging device 32 to perform line exposure or global exposure to capture an optical image based on the control of the system controller 22.

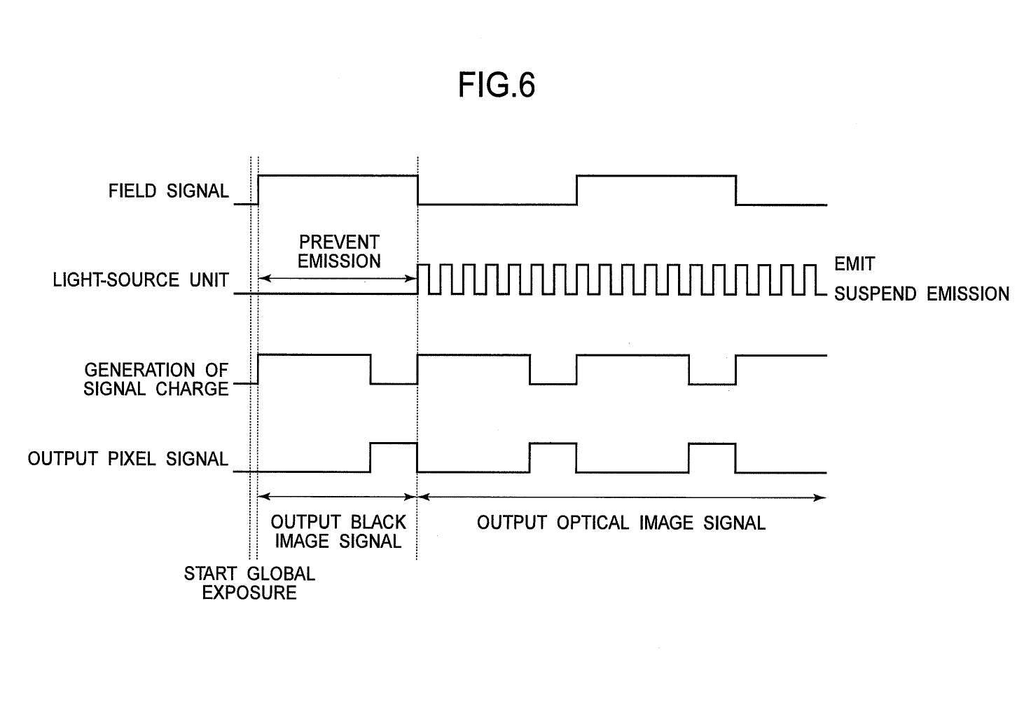

In the first embodiment, the driving method of the imaging device 32 for generation of a black image signal is the same as that for an optical image signal. On the other hand, the driving method of the light-source unit 40 for generation of a black image signal is different from the one for an optical image signal. As shown in FIG. 6, in the first embodiment, the light-source unit 40 is ordered to suspend pulse emission during a field period for generating a black image signal while the light-source unit 40 is ordered to emit pulsed light during field periods for generating optical image signals (see the trace for “light-source unit” in FIG. 6). As described above, the pixel signal which is output while pulse emission is suspended is regarded a black image signal. In addition, pixel signals which are output after the black image signal is output are regarded as optical image signals.

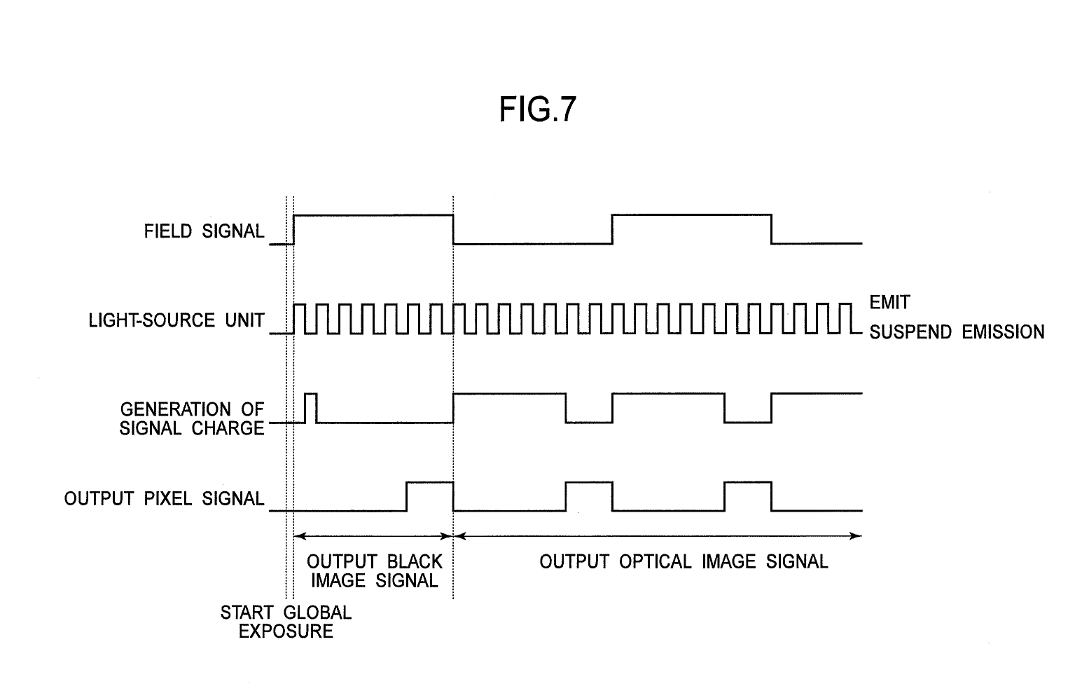

On the other hand, in the second embodiment, the driving method of the light-source unit 40 for generation of a black image signal is the same as of the one for an optical image signal. In addition, the driving method of the imaging device 32 for generation of a black image signal is different from that of an optical image. As shown in FIG. 7, in the second embodiment, the imaging device 32 is ordered to generate signal charges for a black image signal while light is not emitted from the light-source unit 40 on emitting pulsed light (see the trace for “generation of signal charge” in FIG. 7). Incidentally, pixel signals which are output after the black image signal is output are regarded as optical image signals, as in the first embodiment.

The structure and the function of the image-signal processing unit 50 are the same as those of the first embodiment. Accordingly, the image-signal processing unit 50 removes fixed pattern noise from the optical image signal through control by the system controller 22.

In the second embodiment, the endoscope system 10 has a vocal cord observation mode, as in the first embodiment. If a user selects the vocal cord observation mode, the light-source unit 40 is ordered to emit a pulse of white light and the imaging device is ordered to perform global exposure to capture an optical image.

In the second embodiment, a black image signal is generated not only before generating an optical image signal with global exposure but also when initializing the electronic endoscope 30, as in the first embodiment.

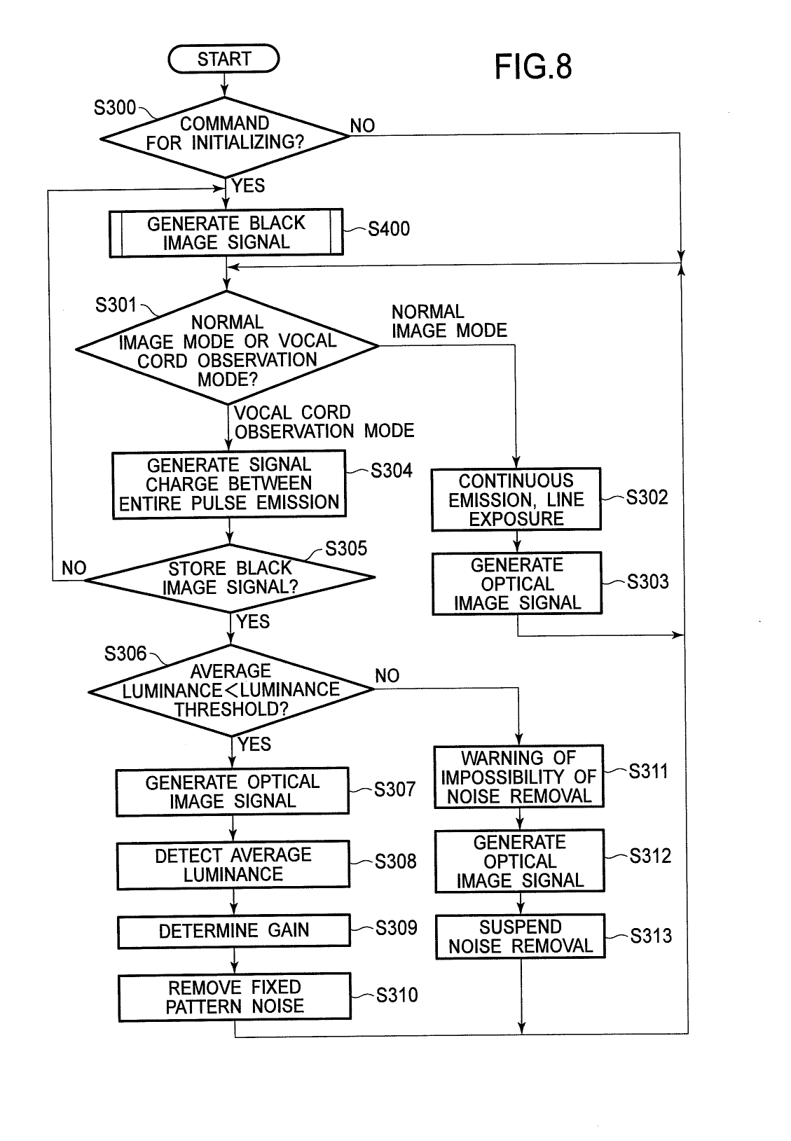

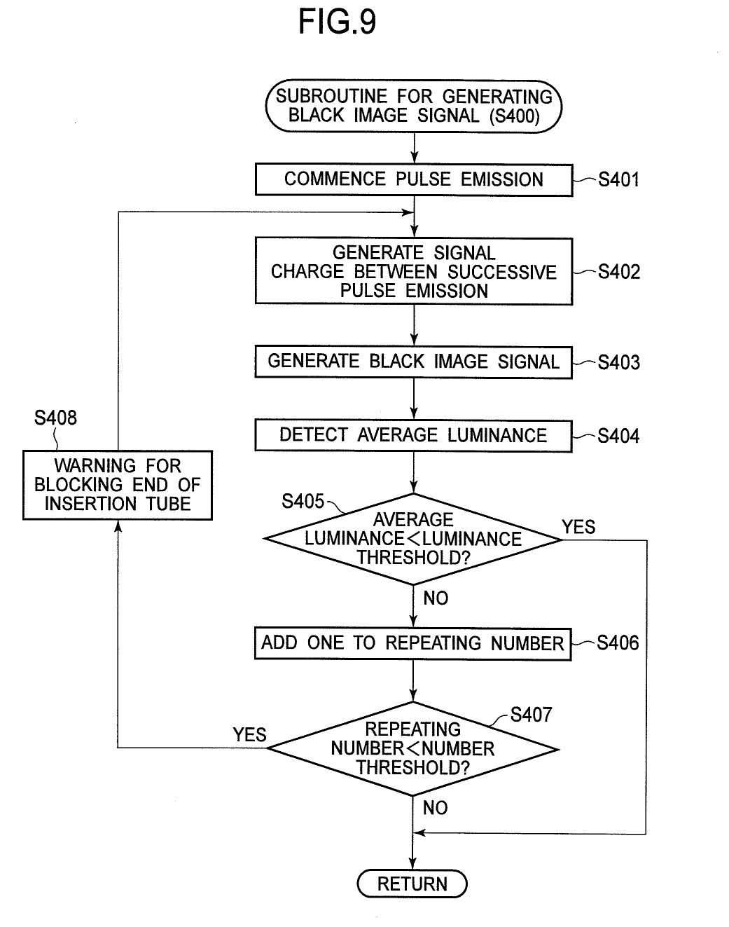

Next, the process used to capture an optical image of a subject and to display the image on a monitor 11 after commencing the endoscope system 20 in the second embodiment is explained using the flowcharts of FIGS. 8 and 9. The process of capturing and displaying terminates when the endoscope processor 20 is switched off.

At step S300, the system controller 22 determines whether or not the input block 23 detects an input of an operational command for initializing. When the input of the operational command is detected, the process proceeds to a subroutine for generating a black image signal (S400). On the other hand, when the input of the operational command is not detected, the process skips the subroutine and proceeds to step S301.

In the subroutine for generating a black image signal (S400), the shutter driver 49 and the imaging device driver 21 orders the rotary shutter 43 and the imaging device 32 so that a black image signal is generated, and the system controller 22 orders the frame memory 52 to store the generated black image signal.

At step S301, the system controller 22 determines either the normal image mode or the vocal cords observation mode is selected.

If the normal image mode is selected, the process proceeds to step S302. At step S302, the system controller 22 orders the light-source unit 40 to continuously emit white light. In addition, the system controller 22 orders the imaging device driver 21 to drive the imaging device with line exposure.

At step S303 following step S302, the imaging device driver 21 orders the imaging device 32 to generate an optical image signal. In addition, the image-signal processing unit 50 carries out predetermined signal processing on the generated optical image signal with line exposure. The optical image signal, having undergone predetermined signal processing is sent to the monitor 11. After sending the optical image signal, the process returns to step S301.

If the vocal cord observation mode is selected at step S301, the process proceeds to step S304. As described below, the pattern of emitted white light of the light-source unit 40 is switched to pulse emission in the subroutine for generating a black image signal (S400) before the process proceeds to step S304. In addition, as described below, the length of the period to receive light for generating signal charges is set to the length of the period during which the emission of white light is suspended between successive light emissions of pulse emission in the subroutine for generating a black image signal (S400). At step S304, the system controller 22 orders the imaging device driver 21 to drive the imaging device 32 with global exposure. In addition, the length of the period for receiving light for generating signal charges is set to the length of the period during which pulsed light is emitted from the light-source unit 40.

At step S305 after ordering the imaging device driver 21, the system controller 22 determines whether the frame memory 52 stores a black image signal. When a black image signal is not stored, the process returns to a subroutine for generating a black image signal (S400). If a black image signal is stored, the process proceeds to step S306.

At step S306, the determination circuit 54 determines whether or not average luminance of an entire image corresponding to the black image signal generated at the subroutine S400 is less than the luminance threshold. When the average luminance is less than the luminance threshold, the process proceeds to step S307. On the other hand, when average luminance exceeds the luminance threshold, the process proceeds to step S311.

At step S307, the imaging device driver 21 orders the imaging device 32 to generate an optical image signal, and then the process proceeds to step S308. At step S308, the second luminance detection circuit 53b detects average luminance of an image corresponding to the optical image signal generated at step S307. After detecting the average luminance, the process proceeds to step S309. At step S309, the diaphragm driver 48 decides an aperture ratio of the diaphragm 42 based on the average luminance detected at step S307, and the system controller 22 decides a gain to multiply a black image signal by based on the decided aperture ratio.

At step S310 following step S309, the multiplier 57 multiplies a black image signal stored in the frame memory 52 by the gain decided at step S309. In addition, the arithmetic circuit 56 removes fixed pattern noise by subtracting the black image signal multiplied by the gain from the optical image signal generated at step S307. In addition, the latter signal-processing circuit 58 carries out predetermined signal processing on the optical image signal which fixed pattern noise is removed from, and then the optical image signal is sent to the monitor 11. After sending the optical image signal, the process returns to step S301.

As described above, when the average luminance of an entire image corresponding to the black image signal exceeds the luminance threshold at step S306, the process proceeds to step S311. At step S311, the latter signal-processing circuit 58 superimposes a warning to informing that noise cannot be removed, such as “image signal for removal of noise is unavailable” on an image corresponding to the optical image signal.

At step S312 following step S311, the imaging device driver 21 orders the imaging device 32 to generate an optical image signal, and then the process proceeds to step S313. At step S313, the system controller 22 orders the arithmetic circuit 56 to suspend the removal of noise from the optical image signal. In addition, the latter signal-processing circuit 58 carries out predetermined signal processing on the optical image signal without removing noise, and then the optical image signal is sent to the monitor 11. After sending the optical image signal, the process returns to step S301.

Next, the subroutine for generating a black image signal (S400) in the second embodiment is explained below.

At step S401, the system controller 22 orders the light-source unit 40 to commence pulse emission. After commencing pulse emission, the process proceeds to step S402. At step S402, the imaging device driver 21 orders the imaging device 32 to generate signal charges while the emission of white light is intermittently being suspended.

At step S403 following step S402, the imaging device driver 21 orders the imaging device 32 to generate an image signal based on the signal charges which are generated at step S402. In addition, the system controller regards the generated image signal as a black image signal, and stores the black image signal in the frame memory 52. After the black image signal is stored by the frame memory, the process proceeds to step S404. At step S404, the first luminance detection circuit 53a detects average luminance of an image corresponding to the stored black image signal.

At step S405 following the detection of the average luminance, the determination circuit 54 determines whether or not the average luminance detected at step S404 less than the luminance threshold. When the average luminance is less than the luminance threshold, the process skips steps S406 and S407, and the subroutine for generating a black image signal (S400) ends. On the other hand, when the average luminance exceeds the luminance threshold, the process proceeds to step S406.

At step S406, the counter 55 adds one to the previous repeating-number, and then the process proceeds to step S407. At step S407, the system controller 22 determines whether the present repeating-number is less than the number-threshold.

When the present repeating-number is less than the number-threshold, the process proceeds to step S408. At step S408, the latter signal-processing circuit 58 superimposes a warning to instruct a user to block an end of the insertion tube, such as “shield the head end of the scope from light” on an image corresponding to the optical image signal. After the warning is superimposed, the process returns to step S402. On the other hand, when the present repeating-number exceeds the number-threshold, the subroutine for generating a black image signal (S400) ends.

In the above second embodiment, when an optical image signal is generated by a CMOS imaging device using global exposure, the effect of fixed pattern noise on an image corresponding to the optical image signal is reduced by generating a black image signal and subtracting the black image signal from the optical image signal generated using global exposure.

In addition, in the above second embodiment, a black image signal is generated when the electronic endoscope 30 is initialized.

When the detected average luminance based on the black image signal exceeds the luminance threshold, another black image signal is ordered to be generated and stored in the frame memory 52 again in the first and second embodiments above. However, generation and storage of another black image signal need not have to be repeated.

When the average luminance based on the black image signal exceeds the luminance threshold, it is supposed that light is incident on the imaging device 32. Then, the black image signal is not equivalent to fixed pattern noise and must not be used for noise reduction. However, the average luminance based on the black image signal will not exceed the luminance threshold barring malfunction of the endoscope system 10. Accordingly, repeated generation of a black image signal until the average luminance is less than the luminance threshold is unnecessary.

When the electronic endoscope 30 is initialized, a black image signal is generated and stored in the frame memory 52 in the first and second embodiments above. A black image signal may not be generated on initializing. As described above, because a black image signal is especially necessary on global exposure, a black image signal should be generated at least when an exposure method for the imaging device 32 is switched to the global exposure method. Of course, it is preferable that the black image signal is generated on initializing so that the user will be able to observe a subject soon after the exposure method of the imaging device 32 is switched to global exposure, as in the first and second embodiments.

A warning to instruct the user to block an end of the insertion tube is displayed on the monitor 11 when the average luminance based on the detected black image signal exceeds the luminance threshold in the first and second embodiment. However, such a warning does not have to be displayed. This is because, as described above, the average luminance based on the black image signal would not exceed the luminance threshold barring malfunction of the endoscope system 10.

A warning that noise cannot be removed is displayed on the monitor 11 and noise reduction is suspended when the repeating-number exceeds the number threshold, in the first and second embodiments above. However, such a warning does not have to be displayed, and noise reduction does not have to be suspended. This is because, as described above, the average luminance based on the black image signal would not exceed the luminance threshold barring malfunction of the endoscope system 10.

The black image signal is multiplied by a gain, in the first and second embodiments above. However, the black image signal may be removed from an optical image signal without multiplying by a gain. The effect of removal of fixed pattern noise may be increased by multiplying a black image signal by a gain.

The gain is determined by the system controller 22 in inverse proportion to the aperture ratio of the diaphragm 42 in the first and second embodiments. However, the gain may be determined by another method. For example, the gain can be determined directly by the user by inputting a command for determination to the input block 23. Or the gain can be determined on the basis of luminance of an image corresponding to an optical image signal. Or the gain can be determined on the basis of a noise portion still included in an optical image signal from which fixed pattern noise has been removed. Or, a black image signal may be multiplied by a fixed gain.

The light-source unit 40 is ordered to suspend the emission for one field period, in the first embodiment above. However, the light-source unit 40 does not have to suspend the emission for an entire field period. The same effect can be achieved as long as the light-source unit 40 is ordered to suspend the emission for a period during which signal charges are generated.

The light-source unit 40 is ordered to emit pulsed white light, in the first embodiment. However, the light-source unit 40 does not have to be ordered to emit pulsed light. The same effect as the above first embodiment can be achieved by suspending the emission of white light during a field period or a frame period to generate a black image signal.

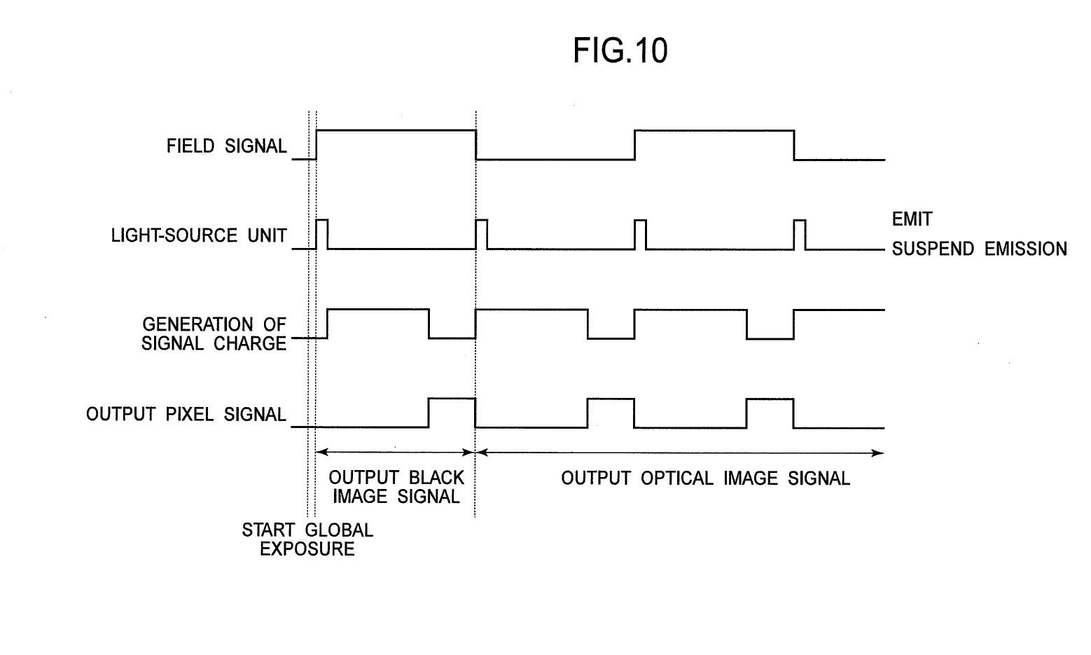

A plurality of pulses of white light is emitted during one field period in the above second embodiment. However, at least one pulse of white light may be emitted during one field period. For example, as shown in FIG. 10, one pulse of white light may be emitted every field period soon after switching the field period between high and low. Then, signal charge for generation of a black image signal should be generated from the suspension of the emission of one pulse of white light until the output of pixel signals is started (see “generation of signal charges” for the black image signal in FIG. 10).

In order to accurately reduce noise, it is preferable that the period for generation of signal charges for a black image signal be near the period for generation of signal charges for an optical image signal. Accordingly, the accuracy of noise reduction will increase by emitting one pulse of white light soon after switching field period between high and low and prolonging the period for the generation of signal charges for a black image signal.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2007-315107 (filed on Dec. 5, 2007), which is expressly incorporated herein, by reference, in its entirety.

1. A noise reduction system comprising:
a switch that switches an exposure method of a CMOS imaging device to global exposure, said CMOS imaging device being mounted in an electronic endoscope and generating an image signal on the basis of signal charges, said signal charges being generated by receiving an optical image of a subject;
a light-source controller that orders illumination of said subject with illumination light to be suspended during a receiving period in at least one field or one frame period after switching said exposure method to said global exposure, said signal charges being generated during said receiving period;
a memory that stores said image signal which is based on said signal charges generated during the suspension period, as a black image signal; illumination of said subject with said illumination light being suspended during said suspension period; and
a noise reduction block that removes fixed pattern noise from an optical image signal on the basis of said black image signal stored in said memory, said optical image signal containing said fixed pattern noise, said optical image signal being said image signal generated based on said signal charges generated while said subject is illuminated with said illumination light.

2. A noise reduction system, according to claim 1, further comprising a first input block that detects a command input for initializing said electronic endoscope,
wherein, upon said first input block detecting said command input for initializing said electronic endoscope,
said light-source controller orders illumination of said subject with said illumination light to be suspended during a receiving period in at least one field or one frame period after detecting said command input for initializing said electronic endoscope,
said memory stores said image signal which is based on said signal charges generated during said suspension period as said black image signal, and
said noise reduction block removes said fixed pattern noise from said optical image signal on the basis of said black image signal stored in said memory.

3. A noise reduction system, according to claim 1, further comprising a luminance calculation block that calculates the luminance of an image corresponding to said black image signal,
said light-source controller suspending the illumination of said subject with said illumination light again during said receiving period, when said luminance of an image corresponding to said black image signal exceeds a first threshold, and
said memory storing said black image signal on the basis of said signal charges generated during said suspension period again.

4. A noise reduction system, according to claim 3, further comprising:
a counter that counts a repeating-number, said repeating-number being the number of times to store said black image signal in said memory; and
a first warning block that warns when said repeating-number counted by said counter exceeds a second threshold.

5. A noise reduction system, according to claim 4, wherein said noise reduction block is ordered to suspend the removal of said fixed pattern noise using said black image signal when said repeating-number exceeds said second threshold.

6. A noise reduction system, according to claim 1, further comprising:
a luminance calculation block that calculates the luminance of an image corresponding to said black image signal; and
a second warning system that warns when the luminance calculated by said luminance calculation block exceeds a first threshold.

7. A noise reduction system, according to claim 1, further comprising an adjustment block that adjusts a signal level of said black image signal by multiplying by a gain before said noise reduction block removes said fixed pattern noise using said black image signal.

8. A noise reduction system, according to claim 7, further comprising a second input block that detects a command input for determining said gain.

9. A noise reduction system, according to claim 7, further comprising a first gain determination block that determines said gain according to the luminance of an image corresponding to said optical image signal.

10. A noise reduction system, according to claim 7, further comprising:
a status detector that detects a status of a diaphragm, said diaphragm adjusting an amount of said illumination light; and
a second gain determination block that determines said gain according to said status of said diaphragm detected by said status detector.

11. A noise reduction system comprising:
a switch that switches an exposure method of a CMOS imaging device to global exposure, said CMOS imaging device being mounted in an electronic endoscope, said CMOS imaging device generating an image signal on the basis of signal charges, said signal charges being generated by receiving an optical image of a subject illuminated with pulsed illumination light, said image signal corresponding to said optical image;
an imaging device controller that orders said CMOS imaging device to generate said signal charges while illumination of said subject with illumination light is suspended in at least one field or one frame period after switching said exposure method to said global exposure;
a memory that stores said image signal which is based on signal charges generated during the suspension period, as a black image signal, illumination of said subject with said illumination light being suspended during said suspension period; and
a noise reduction block that removes fixed pattern noise from an optical image signal on the basis of said black image signal stored in said memory, said optical image signal containing said fixed pattern noise, said optical image signal being said image signal generated based on said signal charges generated while said subject is illuminated with said illumination light.

12. A noise reduction system, according to claim 11, further comprising a first input block that detects a command input for initializing said electronic endoscope,
wherein, upon said first input block detecting said command input for initializing said electronic endoscope,
said imaging device controller orders said CMOS imaging device to generate said signal charges while illumination of said subject with illumination light is suspended in at least one field or one frame period after detecting said command input for initializing said electronic endoscope,
said memory stores said image signal which is based on said signal charges generated during said suspension period as said black image signal, and
said noise reduction block removes said fixed pattern noise from said optical image signal on the basis of said black image signal stored in said memory.

13. A noise reduction system, according to claim 11, further comprising a luminance calculation block that calculates the luminance of an image corresponding to said black image signal,
said imaging device controller ordering said CMOS imaging device to generate said signal charges while illumination of said subject with illumination light is suspended, when said luminance of an image corresponding to said black image signal exceeds a first threshold, and
said memory storing said black image signal on the basis of said signal charges generated during said suspension period again.

14. An endoscope processor comprising:
a switch that switches an exposure method of a CMOS imaging device to global exposure, said CMOS imaging device being mounted in an electronic endoscope, said CMOS imaging device generating an image signal on the basis of signal charges, said signal charges being generated by receiving an optical image of a subject, said image signal corresponding to said optical image;
a light-source controller that orders illumination of said subject with illumination light to be suspended during a receiving period in at least one field or one frame period after switching said exposure method to said global exposure, said signal charges being generated during said receiving period;
a memory that stores said image signal which is based on said signal charges generated during the suspension period, as a black image signal, illumination of said subject with said illumination light being suspended during said suspension period; and
a noise reduction block that removes fixed pattern noise from an optical image signal on the basis of said black image signal stored in said memory, said optical image signal containing said fixed pattern noise, said optical image signal being said image signal generated based on said signal charges generated while said subject is illuminated with said illumination light.

15. An endoscope processor comprising:
a switch that switches an exposure method of a CMOS imaging device to global exposure, said CMOS imaging device being mounted in an electronic endoscope, said CMOS imaging device generating an image signal on the basis of signal charges, said signal charges being generated by receiving an optical image of a subject illuminated with pulsed illumination light, said image signal corresponding to said optical image;
an imaging device controller that orders said CMOS imaging device to generate said signal charges while illumination of said subject with illumination light is suspended in at least one field or one frame period after switching said exposure method to said global exposure;
a memory that stores said image signal which is based on signal charges generated during the suspension period, as a black image signal, illumination of said subject with said illumination light being suspended during said suspension period; and
a noise reduction block that removes fixed pattern noise from an optical image signal on the basis of said black image signal stored in said memory, said optical image signal containing said fixed pattern noise, said optical image signal being said image signal generated based on signal charges generated while said subject is illuminated with said illumination light.

16. An endoscope system comprising:
an electronic endoscope that comprises a CMOS imaging device, said CMOS imaging device generating an image signal on the basis of signal charges, said signal charges being generated by receiving an optical image of a subject, said image signal corresponding to said optical image;
a switch that switches an exposure method of said CMOS imaging device to global exposure;
a light-source controller that orders illumination of said subject with illumination light to be suspended during a receiving period in at least one field or one frame period after switching said exposure method to said global exposure, said signal charges being generated during said receiving period;
a memory that stores said image signal which is based on said signal charges generated during the suspension period, as a black image signal, illumination of said subject with said illumination light being suspended during said suspension period; and
a noise reduction block that removes fixed pattern noise from an optical image signal on the basis of said black image signal stored in said memory, said optical image signal containing said fixed pattern noise, said optical image signal being said image signal generated based on said signal charges generated while said subject is illuminated with said illumination light.

17. An endoscope system comprising:
an electronic endoscope that comprises a CMOS imaging device, said CMOS imaging device generating an image signal on the basis of signal charges, said signal charges being generated by receiving an optical image of a subject, said image signal corresponding to said optical image;
a light source that emits pulsed illumination light for illuminating said subject;
a switch that switches an exposure method of said CMOS imaging device to global exposure;
an imaging device controller that orders said CMOS imaging device to generate said signal charges while illumination of said subject with said illumination light is suspended in at least one field or one frame period after switching said exposure method to said global exposure;
a memory that stores said image signal which is based on signal charges generated during the suspension period, as a black image signal, illumination of said subject with said illumination light being suspended during said suspension period; and
a noise reduction block that removes fixed pattern noise from an optical image signal on the basis of said black image signal stored in said memory, said optical image signal containing said fixed pattern noise, said optical image signal being said image signal generated based on signal charges generated while said subject is illuminated with said illumination light.
